(19) United States
(12) Patent Application Publication
(10) Pub. No.: US 2006/0015465 A1
(43) Pub. Date: Jan. 19, 2006

(54) Apparatus, method and program for license information ascertainment

(76) Inventors: Hiroshi Kume, Tokyo (JP); Hideyuki Urita, Kanagawa (JP); Haruki Yanbe, Kanagawa (JP)

Correspondence Address: RABIN & BERDO, P.C., Suite 500, 1101 14th Street, Washington, DC, 20005, US

(21) Appl. No.: 11/065,068

(22) Filed: Feb. 25, 2005

(30) Foreign Application Priority Data
Jul. 13, 2004 (JP) 2004-206219

(51) Int. Cl. G06F 17/60

(52) U.S. Cl. 705/59

(57) ABSTRACT

A license information ascertainment device ascertains whether software to be executed conforms to an appropriate license contract. The license information ascertainment device includes a verification circuit for determining coincidence with verification information included in the software so as to verify the legitimacy of execution of the software. The license information ascertainment device also includes a storage unit for temporarily storing the verification results provided from the verification circuit. The license information. ascertainment device also includes an output circuit. Upon receiving a read signal, the output circuit reads the verification results from the storage unit, and prepares rights ownership information and/or license information for the software based on the verification results.

### BACKGROUND OF THE INVENTION

1. Field of the Invention

This invention relates to a license information ascertainment method, and in particular relates to a license information ascertainment method that includes reading license information relating to the software of a system LSI device incorporated in for example a printed circuit board, so as to ascertain whether the software is an illicit copy and whether the software violates the license agreement. This invention also relates to a license information ascertainment device, and license information ascertainment program.

2. Description of the Related Art

With progress in system LSI technology in recent years, it has become possible to procure inexpensive LSI devices, and so equipment incorporating system LSI devices has come into widespread use. The spread of, for example, portable telephones and other portable equipment has been particularly rapid, and in order to further expand sales emphasis has been placed on the design and external appearance of portable telephones, while in addition requiring a wide variety of sophisticated functions. Consequently the software development industry has been engaged in the development of software providing diverse functions. Of late the embedded software which drives the internally embedded system LSI device tends to be frequently upgraded, even when there are no major changes to the hardware. As a result, the software development industry tends to emphasize the value of software over that of hardware, and is tending to obtain profits by entering into detailed licensing agreements with the manufacturers of portable telephones and other products.

Sales of embedded software normally take the form of providing source code. Although source code is kept strictly confidential within a software development enterprise, once provided to an outside party, the source code can be easily copied. Thus, there are presumably numerous cases of acts of copyright infringement and violations of license contracts. In particular, when the source code is compiled and takes the form of object code, it is difficult to directly identify the software copyright holder.

Referring to FIG. 2 of the accompanying drawings, problems with sales of licenses for such embedded software are described. Company O is the copyright holder who has developed the software, and company A is a user who has concluded a license contract with the company O. Hence with respect to use of the software, the company O and company A are respectively the licenser and the licensee.

A first problem arises when another user (company B) who has not concluded a license contract with the company O (an unlicensed user) obtains, by some means, the software, installs (embeds) the software in a lawfully purchased system LSI device, and executes the software.

For example, the user company B may place a system LSI device and nonvolatile memory such as flash memory, as firmware, on a printed circuit board of portable equipment, and may write the object code of the software to the flash memory. Then, the company B is able to operate the portable equipment, despite the fact of not having concluded any license contract for the software.

A second problem arises when the company A, which has concluded a license contract with the company O, modifies the software in violation of the license contract, and executes the modified software.

In some cases a license contract may be concluded which permits a certain degree of modification of the object code, without providing guarantees of operation. In fact, object codes change even depending on the options used when compiling. However, the contract may prohibit modification of the supplied software. In particular, the licensing company O may contractually prohibit any modification of the program if the company O itself makes the program and the program controls the core portion of the system. In such cases, because there are frequent requests to the company A from customers for changes to specifications, the company A may modify the software in violation of the license contract, for the purpose of alleviating the burden of development. It is easy for a licit user company A to make such modifications to source code because the source code is in its hand. Hence the licensing company O may desire to detect such actions. The foregoing is for example disclosed in Japanese Patent Kokai (Laid-open Application) No. 9-69044.

### SUMMARY OF THE INVENTION

As described above, when the software of the licensing company O or the modified software is embedded, executed, or otherwise utilized through an act of copyright infringement or license contract violation, the company O desires to clearly state the fact of this infringement or violation, not only to itself, but also to the infringing party or violator. In this case, it is at least necessary to identify the software and the license contract. It is desirable that identification of the software includes matching a specific portion of the object code provided under the license contract.

After the software has been embedded in portable equipment or similar, however, it is not easy to identify the software without destroying the portable equipment. It can be inferred, from the functions of the completed portable equipment, that the software for which there has been license contract violation is embedded in the portable equipment. However, the licensing company O does not hold corroborative proof of this fact.

Certain types of portable equipment may enable insertion and replacement of an EPROM in a socket as firmware. However, due to spatial constraints, recent portable equipment generally adopts flash memory, in a configuration enabling 4. electrical overwriting at a later date; consequently removal of the object code is not simple.

There are flash memory devices designed such that a mode to read the memory contents can be set through operation of a specific terminal (pin). It should be noted, however, that a primary object of this invention is not to merely obtain the object code, but to determine, by a simple manner, whether the object code conforms to the license contract or similar. More specifically, the primary purpose of the present invention is, by judging whether the object code conforms to a license contract or similar, to clearly show a party concerned a fact that an action of the party constitutes copyright infringement or license contract violation.

If the object code addressed by a license contract includes information relating to the license contract, and if it is possible to read the license information by simple means, then, at least, a contention of copyright infringement can be made to an illicit user B who supplies the portable equipment. That is, the illicit user B has used the software without receiving the consent of the copyright holder O.

If the object code can be identified through a software control number or similar, instead of the license information, and it is possible to detect revision of a specific portion of the object code in violation of the license contract, then the company O can contend license contract violation to the licit user A.

It is true, on the other hand, that if in any case the user has substantial technical capability enough to read the license information or similar, then the user would be able to modify the software, and evade detection thereof. Hence a method employing encryption or similar is conceivable, with the object of complete concealment. However, a main object of this invention is simply to clearly state the fact of violation of the license contract or similar. Use of encryption or the like is also possible, but this might be extraneous to the main object of the present invention.

According to a first aspect of the present invention, there is provided an improved license information ascertainment device which ascertains whether executed software conforms to a license contract. The license information ascertainment device includes a verification circuit for determining coincidence with verification information included in the software, so as to verify the legitimacy of execution of the software. The license information ascertainment device may also include a storage circuit for temporarily storing the result of verification by the verification circuit. The license information ascertainment device may also include an output circuit for reading, when a read signal is input, the verification result from the storage circuit. The output circuit generates information relating to ownership of rights and/or license information for the software based on the verification result.

When a read signal is input, whether execution of the software conforms to a license contract and is legitimate can be verified, and the verification result can be output. Thus, the fact of infringement or of license contract violation can be easily ascertained, and the fact of infringement or of license contract violation can be clearly stated to the party infringing exclusive rights or to the license contract violator. As a result, an effective method of verification can be provided to a party attempting to expand sales of software through license contracts and similar for object code in particular.

According to a second aspect of the present invention, there is provided an improved license information ascertainment method for ascertaining whether executed software conforms to a license contract. In this license information ascertainment method, a determination is made as to coincidence with verification information included in the software to verify the legitimacy of execution of the software. The verification result is used to provide information relating to ownership of rights and/or license for the software information.

According to a third aspect of the present invention, there is provided a license information ascertainment program for ascertaining whether executed software conforms to a license contract. This program causes a computer to function as verification means, which judges coincidence with verification information included in the software to verify the legitimacy of execution of the software. The program may also cause the computer to function as storage means, which temporarily stores the result of verification by the verification means. The program may also cause the computer to function as output means which reads, when a read signal is input, the verification result from the storage means, and outputs information relating to ownership of rights and/or license information for the software based on the read verification result.

### BRIEF DESCRIPTION OF THE DRAWINGS

FIG. 1 is a schematic diagram useful to explain a license information ascertainment method according to a first embodiment of the present invention;

FIG. 2 is a drawing useful to explain problems with license sales of embedded software;

FIG. 3 is a block diagram to show the hardware configuration of a system LSI device of the first embodiment of the present invention;

FIG. 4A illustrates an example of license information of the first embodiment;

FIG. 4B illustrates an example of verification information of the first embodiment;

FIG. 5 shows the configuration of a license register of the first embodiment;

FIG. 6 is a flowchart showing operation to output license information in the first embodiment;

FIG. 7 illustrates a block diagram to show the hardware configuration of a system LSI device of a second embodiment of the present invention;

FIG. 8A is a set of output waveform diagrams showing examples of output waveforms generated by the waveform output circuit of the second embodiment;

FIG. 8B is another set of output waveform diagrams showing examples of output waveforms generated by the waveform output circuit;

FIG. 9 is a configuration drawing useful to explain a third embodiment of the present invention;

FIG. 10 illustrates a block diagram of a mobile communication device of the third embodiment; and,

FIG. 11 shows an example of a communication format configuration in the third embodiment.

### DETAILED DESCRIPTION OF THE INVENTION

Below, embodiments of a license information ascertainment device, license information ascertainment method, and license information ascertainment program of this invention are described, referring to the drawings.

### First Embodiment

An outline of a first embodiment of a license information ascertainment device, license information ascertainment method, and license information ascertainment program of this invention is described.

In this embodiment, a case is described in which, upon executing an application program the copyright holder of which is company O, information on the ownership of the copyright to the application program and information relating to licensing is caused to be output and ascertained.

The license information ascertainment method of the first embodiment is a method in which a portion of an application program is a program which outputs license information, and when a specific input terminal (hereafter called the output program startup input terminal) of a specific register (hereafter called the license register) is active, the license information output program is started, and license information supplied to a specific terminal (hereafter called the license information output terminal) of the system LSI device. The license information output program ascertains the identity of, at least, the license information based on the license information or similar, and also ascertains the identity of object code for a portion modification of which is prohibited under the license contract.

The license information output program first ascertains the identity of license information by comparison of the license information with a table of hashed values (hereafter called a “hash table”), and then ascertains the identity of object code in a portion modification of which is prohibited under the license contract through comparison of the object code with a table which allocates parity values to a plurality of object code items (hereafter called a “parity table”), in order to incorporate the ascertainment results in the license information or similar. Input to the output program startup input terminal is possible at any time during application program execution, and the license information output program inspects the input value.

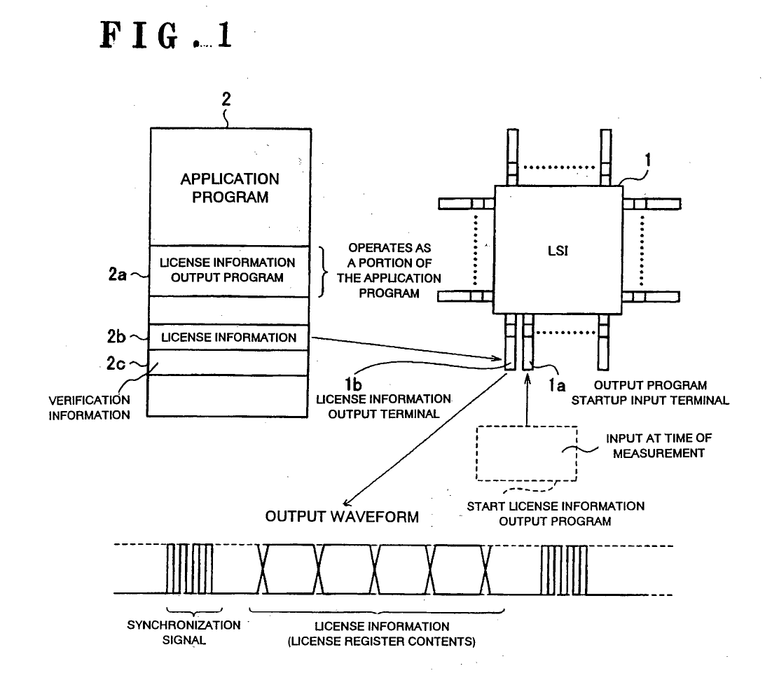

Now, the first embodiment is described in detail, referring to FIG. 1 through FIG. 6.

FIG. 1 is a drawing which systematically explains a license information ascertainment method of the first embodiment. Specifically, FIG. 1 shows the external appearance of a system LSI device 1 having a plurality of input or output terminals, as well as an image of an application program 2 executed by the system LSI device 1, and output waveforms generated by the system LSI device 1.

In FIG. 1, the system LSI device 1 is an integrated circuit which executes the application program 2, embedded for example in flash memory or another storage device. The system LSI device 1 has an output program startup input terminal 1a, for input of a startup bit to start an output program, as well as a license information output terminal 1b to output license information.

During execution of the application program 2, the system LSI device 1 monitors the input of an active input signal to the output program startup input terminal 1a. Upon receiving an active input signal, the system LSI device 1 executes the license information output program 2a included in the application program 2 to ascertain the identity of the object code of the application program 2 and the identity of the copyright information and license information (hereafter “license information”), and outputs license information including this verification result from the license information output terminal 1b. The detailed internal configuration of the system LSI device 1 will be described later.

The application program 2 is a functional program, embeddable in the system LSI device 1. The functions of the application program 2 are realized through execution in the system LSI device 1. As shown in FIG. 1, the application program 2 is configured to have, in a portion thereof, the license information output program 2a.

The license information output program 2a monitors the output program startup input terminal 1a during execution of the application program 2. When there is active input to the output program startup input terminal 1a, the license information output program 2a is started. The license information output program 2a uses verification information to verify that the object code and license information of the application program 2 are legitimate, and outputs the license information.

It is desirable that the license information output program 2a be a program which controls the core portion of the system and which is provided directly by the licensing company O, or a program which is executed when a program controlling the core portion of the system is executed, and that the license information output program 2a be placed in a portion of the program modification of which is contractually prohibited. One reason for this is in order not to impede development of the application program 2 by the user. Another reason is that, because modification by the user is prohibited, the license information output program 2a itself can be included in the ascertainment of the identity of the object code.

Though not adopted in the illustrated embodiment, the system LSI device 1 may periodically execute the license information output program 2a through a timer interrupt or similar. Such configuration is not adopted in this embodiment because the use of timer interrupts or other resources would impede development of the application program 2.

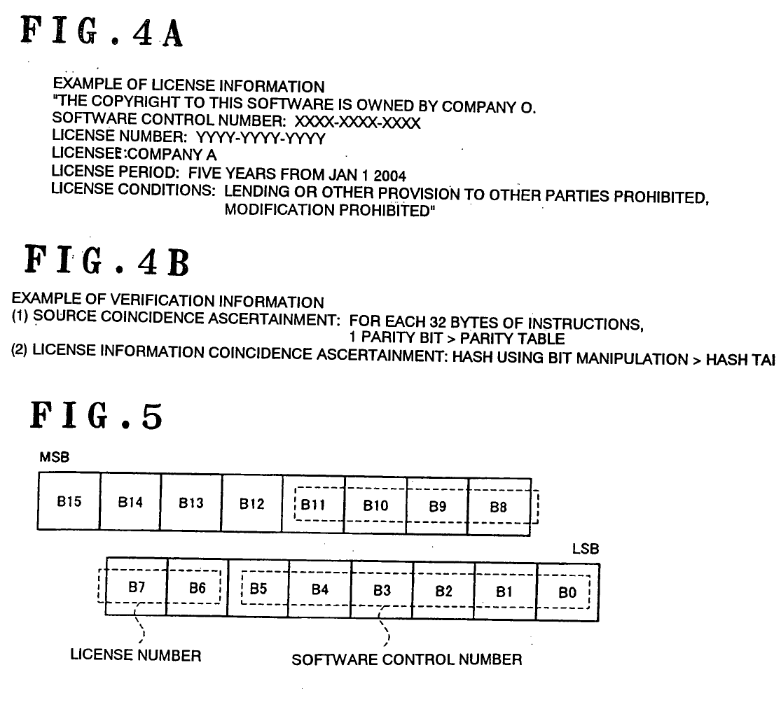

In this embodiment, the application program 2 includes the license information 2b and verification information 2c. FIG. 4A shows an example of license information 2b and FIG. 4B shows an example of verification information 2c.

The license information 2b is information of copyright indication and license of the application program 2, and may include information identifying the licenser and copyright holder, information identifying the software covered by the license, information identifying the license contract itself, information identifying the licensee, license period information, and license condition information. In the example shown in FIG. 4A, the license information is “The copyright to this software is owned by Company O. Software control number: XXXX-XXXX-XXXX, license number: YYYY-YYYY-YYYY, licensee: Company A, license period: for the five years from Jan. 1 2004, license conditions: lending or other provision to other parties prohibited, modification prohibited”.

The verification information 2c is information used upon verification of the object code and license information through execution of the license information output program 2a. In this embodiment, the verification information 2c generally consists of two portions; one is used to ascertain coincidence of the object code for the software covered by the license, and the other is used to ascertain coincidence of the license information. The verification information 2c of this embodiment also includes information used to verify the verification information itself; however, in the following description the verification information for object code verification and verification information for license information verification are described in detail. Separate verification portions are prepared according to the object for verification because the object code and license information are of substantially different character. In this embodiment, it is assumed that the contents of the two verification information portions differ according to the information for verification (the object code and license information).

In this embodiment, the object code does not include license information, but in essence consists only of instruction codes. Hence the object code accounts for nearly all of the source code provided to the licensee. This is because, if an attempt were made to verify complete identity of the object code using verification information, the verification information itself would require a considerable amount of information.

Use of the verification information having a considerable amount of information would result in undesired situations. Specifically, the overall size of the source code would be increased needlessly, thereby adding constraints to the development of the application program 2. Also, there is a limit to the storage space existing in the flash memory and other parts.

Hence it is expedient to sacrifice some degree of accuracy in ascertaining the identity of the object code when performing verification. In this embodiment, verification of the object code is essayed in a manner shown in FIG. 4B. For example, in the method of ascertaining coincidence of the object code in this embodiment, one parity bit is assigned for every 32 bytes of instructions. Hence, for example, 8 kbytes of verification information is required for 2 Mbytes of object code. Even this degree of verification enables judgment as to whether there have been major modifications to the object code. The entirety of the verification information employing parity is held in a parity table, and appended to the application program 2.

On the other hand, each word of the license information must be accurate. This is because if the licenser cannot be identified, it is not possible to clearly state and claim to the other party that the licenser is the copyright holder. In this embodiment, as shown in FIG. 4B, the hashing using bit manipulation is employed for the verification information for license information. Because it is expected that the volume of license information is not large, the entirety of the license information may be encrypted. The encryption is in fact possible, but the encryption is not carried out in this particular embodiment because the encryption and decryption may not be easy, and concealment is not itself a primary object of the invention. As the bit computation to generate hash values, for example, the PJW hash method (Aho, Sethi and Ullman, pp. 434-438), which utilizes the special properties of ASCII (American Standard Code for Information Interchange) code, may be used. Because it is expected that the amount of license information is not large, the burden imposed by hash value calculations will be small. The entirety of hash-related verification information is placed in a hash table, which is appended to the application program 2. When a hash value obtained from the hash function is found in the hash table, the license information is determined to be identical, and when not in the hash table, the license information is determined not to be identical.

Referring back to FIG. 1, an example of the output waveform of license information generated from the system LSI device 1 is shown in the lower part of the drawing. The output waveform example of FIG. 1 is a waveform issued from a data output circuit (described below) of the system LSI device 1. A synchronization signal is also output when the license information is output. The output waveform of FIG. 1 may be generated repeatedly. This is to facilitate reading of the output waveform when observing the output waveform using a logic analyzer or similar which can be connected to a downstream end of the system LSI device 1. The output license information is the temporarily stored contents of the license register in the system LSI device 1. This output of the contents of the license register is used because preparation of license information in a different format for each license tends to result in complexity when managing license information, and such complexity is not desirable.

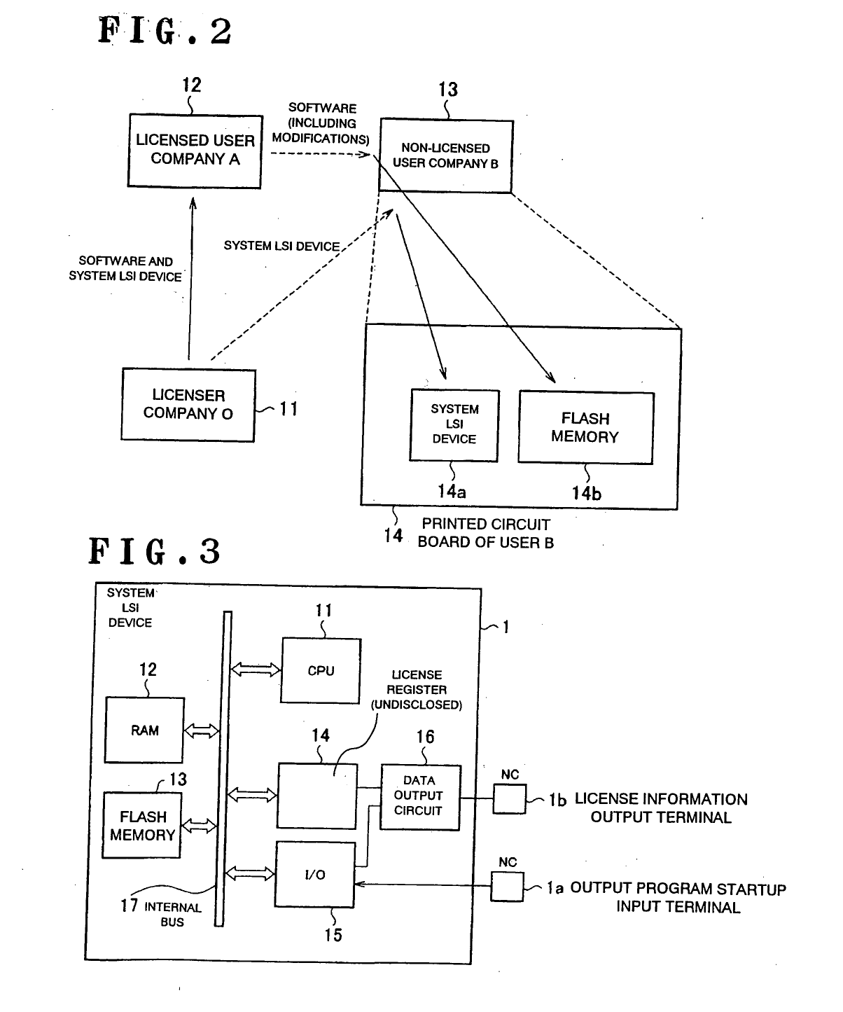

FIG. 3 illustrates an internal hardware configuration of the system LSI device 1 of the first embodiment. As shown in FIG. 3, the system LSI device 1 has a CPU 11, RAM 12, flash memory 13, license register 14, input/output (I/O) circuit 15, and data output circuit 16, connected via an internal bus 17. The system LSI device 1 also has an output program startup input terminal 1a and license information output terminal 1b.

The CPU 11 controls the functions and operations of the system LSI device 1. The CPU 11 realizes processing program functions by executing a processing program stored in the RAM 12 and/or flash memory 13. The RAM 12 stores the processing program to be executed by the CPU 11, and/or data necessary for execution of the processing program. The flash memory 13 stores the application program 2 and other information.

When the license information output program 2a is started during execution of the application program 2, the license number and software control number of the application program 2 are introduced to the license register 14. Also, the object code and license information verification results for the application program 2 by the license information output program 2a are introduced to the license register 14. These are temporarily stored in the license register 14. When an undisclosed I/O address is specified by an I/O control circuit (not shown) of the license register 14 and the license information output terminal 1b is selected, and when at the same time there is active input to the output program startup input terminal 1a, the license register 14 outputs the information which had been stored temporarily as license information from the license information output terminal 1b, via the data output circuit 16.

The license register 14 is undisclosed publicly, and is not for example described in a user manual or other publication.

Input to the output program startup input terminal 1a is possible at any time during execution of the application program 2, and the input value is inspected by the license information output program 2a. When the logical value of the output program startup input terminal 1a is “L”, startup of the license information output program 2a itself is performed. Alternatively, the output program startup input terminal 1a may be set to a prescribed value at power-on. In this case, upon power-on, set up of the internal register may be performed, and the license information output program 2a may inspect the internal register.

When the system LSI device 1 is a CMOS device, it is preferred that the output program startup input terminal 1a has high resistance and is pulled up. It is desired that the output program startup input terminal 1a be an NC (no connection) pin; but when a terminal cannot be added to the system LSI device 1, an input terminal having another function may also be used for this purpose. It is likewise desirable that the license information output terminal 1b be an NC pin, but when a terminal cannot be added to the system LSI device 1, an output terminal having another function can also be used for this purpose. In the user manual, the output program startup input terminal and license information output terminal are preferably designated “reserved” terminals, so that use of these terminals by the user is prohibited.

Next, the configuration of the license register 14 of this embodiment is described with reference to FIG. 5.

As shown in FIG. 5, a 16-bit register is employed as the license register 14 of this embodiment, with the following meanings assigned to each bit. The number of bits of the license register 14 is not limited to 16, and for example a 32-bit register may be employed as the license register 14.

In FIG. 5, bit B15 indicates non-coincidence/coincidence of license information. Bit B15 is reset when the license information is coincident, and is set when not coincident.

Bit B14 indicates non-coincidence/coincidence of object code. Bit B14 is reset when object code is coincident, and is set when not coincident.

Bit B13 indicates non-coincidence/coincidence of verification information itself. Bit B13 is reset when verification information itself is coincident, and is set when not coincident.

Bit B12 is a reserved bit and is not used. This bit can for example be used as a bit indicating whether inspection has already been performed, or as a bit indicating the validity of the license information.

Bits B11 to B6 hold the license number, and are bits identifying the license contract.

Bits B5 to B0 hold the software control number, and are bits identifying the software of the license.

Hence when there is a need for strict management of the license number and software control number, or when there is a need to allocate numerous bits to the license number or other number, the license register 14 will preferably have a 32-bit configuration.

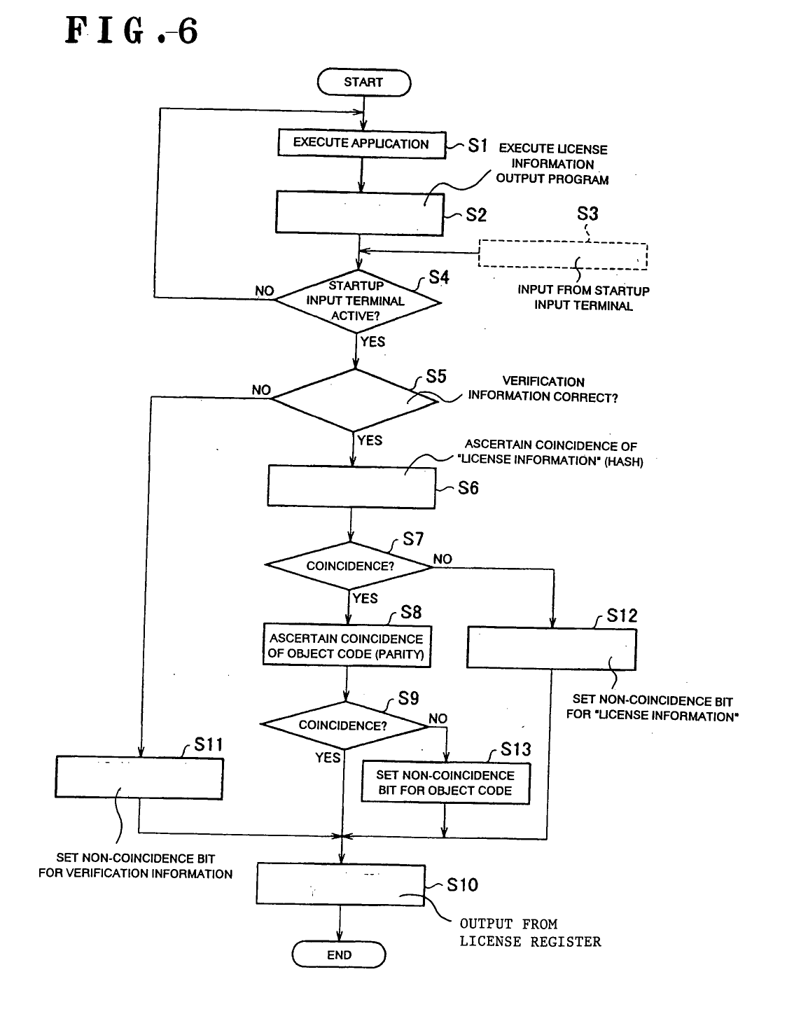

Next, the method of ascertaining license information is described with reference to FIG. 6 which is an operational flowchart to generate the license information.

In FIG. 6, when power-on reset of the system LSI device 1 occurs, the application program 2 is executed (S1).

When a particular program in the application program 2 controlling the core portion of the system is executed, the license information output program 2a is also executed (S2).

By executing the license information output program 2a, the output program startup input terminal 1a is monitored, and a determination is made as to whether the output program startup input terminal 1a is active or not (S4).

When the output program startup input terminal 1a is not active, the user application program 2 itself is executed as usual (S4).

On the other hand, if the output program startup input terminal 1a is active (S3), the license information output program 2a is executed, and the processing of S5-S13 is performed. In this embodiment, the input to the output program startup input terminal (S3) can be entered at any time during execution of the application program.

By executing the license information output program 2a, firstly, the legitimacy of the verification information 2c itself is ascertained (S5).

In this embodiment, the verification information 2c includes information to verify the verification information 2c itself; using this information, the legitimacy of the verification information 2c is determined.

When the verification information 2c is judged to be legitimate, bit B13 of the license register 14 is reset (S5). If, on the other hand, the verification information 2c has been revised or otherwise changed and is not legitimate, bit B13 is set (S11).

When the verification information 2c is judged to be legitimate, the license information output program 2a is executed so that secondly, the identity of the license information 2b is ascertained (S6).

Ascertainment of the identity of the license information 2b is performed by determining whether there is complete coincidence between the hash value in a hash table prepared in advance as verification information 2c, and a hash value calculated using a hash function prepared in advance (S7).

When there is complete coincidence of the hash values, license information 2b is judged to be in complete coincidence, and bit B15 of the license register 14 is reset (S7); when there is any non-coincidence, license information 2b is judged not to be in complete coincidence, and bit B15 of the license register 14 is set (S12).

When the license information 2b is determined to be legitimate, the license information output program 2a is executed so that thirdly, coincidence of object code is ascertained for that portion of the application program 2 whose program modification is prohibited by the license contract (S8).

Ascertainment of the identity of object code is performed by determined whether there is complete coincidence of a parity value in a parity table prepared in advance as verification information 2c, and a calculated parity value (S9).

Bit B14 of the license register 14 is reset only when there is complete coincidence of the parity values (S9); if there is any non-coincidence, bit B14 of the license register is set (S13).

In this embodiment, coincidence of object code is limited only to instruction code, and does not include license information 2b or verification information 2c. It should also be noted that the license information output program 2a can be included in ascertainment of the coincidence of object code.

When identity of the license information 2b and object code is verified, next the license information output program 2a is executed, and the stored contents of the license register 14 are supplied, together with a synchronization signal, to the license information output terminal 1b via the data output circuit 16 (S10).

A logic analyzer which can be connected to the license information output terminal 1b is able to capture one occurrence of the output waveform from the license information output terminal 1b; but in consideration of the probable use with a synchroscope, the data output circuit 16 may periodically and repeatedly issue the output waveform.

As described above, by connecting a logic analyzer to the license information output terminal 1b and causing the logical analyzer to read the contents of the license register 14, license information relating to software embedded in flash memory and other information can be easily read.

If a malevolent illicit user modifies the license information output program or the verification information, this invention would not be able to detect such copyright infringement or similar behaivor. For example, modification such that no license information at all would be output is possible. However, a primary object of this invention is to simply determine whether the object code conforms to a license agreement or the like, and a more specific object is to clearly state to the violator the fact of violation of the license contract or copyright. Clearly this invention conforms to such an object, and malevolent illicit users are excluded at the outset.

### Second Embodiment

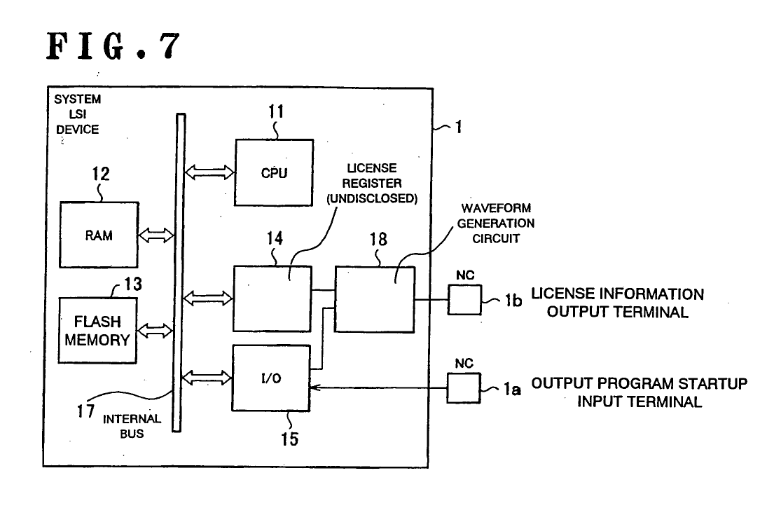

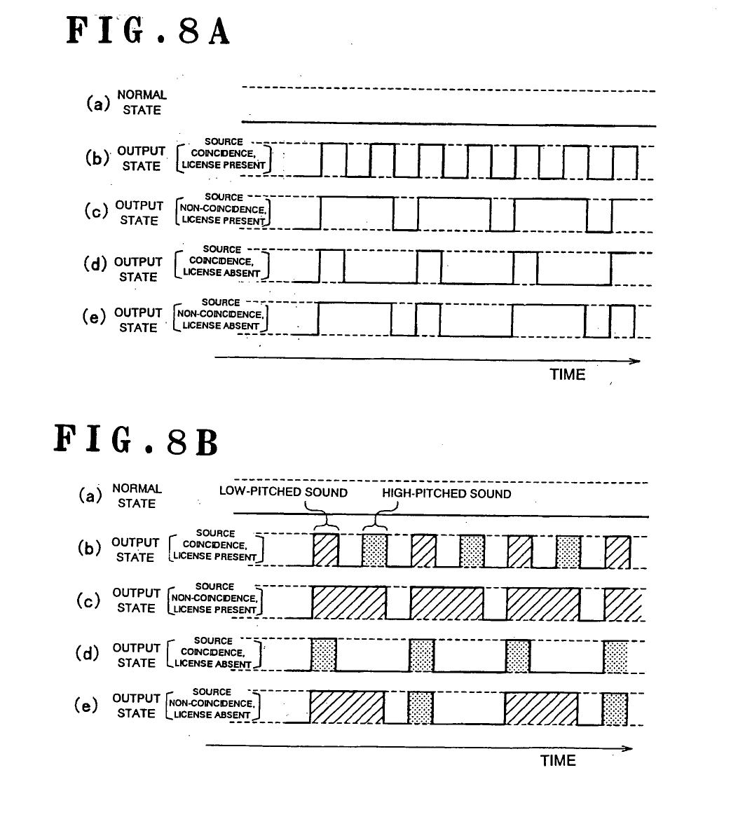

Next, a second embodiment of the present invention is described with reference to FIG. 7 and FIG. 8. In the first embodiment, the primary object is accurate identification of the license number or similar. However, it is more convenient to clearly state to the other party by a simple manner whether permission to use the software has been granted, whether there has been software modification, and similar. Hence in the second embodiment, a method is provided for making a clear statement to the other party using several types of regular waveforms according to the results of verification of object code and license information.

FIG. 7 shows the hardware configuration of a system LSI device 1 of the second embodiment. Similar symbols are used to designate similar elements in the first and second embodiments.

As shown in FIG. 7, the system LSI device 1 has a CPU 11, RAM 12, flash memory 13, license register 14, I/O 15, and waveform output circuit 18, connected via an internal bus 17. The system LSI device 1 also has an output program startup input terminal 1a and license information output terminal 1b.

In FIG. 7, the system LSI device 1 of the second embodiment is characterized in having, in addition to a license register 14 not disclosed publicly in for example a user manual or similar, a waveform output circuit 18.

In the first embodiment, the data output circuit 16 extracts the contents of the license register 14 and supplies the contents to the license information output terminal 1b; in the second embodiment, the waveform output circuit 18 supplies to the license information output terminal 1b several types of regular waveforms, based on the contents of the license register 14.

The method of ascertaining the identity of the object code and license information for the application program 2 in the system LSI device 1 is similar to that of the first embodiment. That is, during execution of the application program 2, the system LSI device 1 monitors whether there is active input to the output program startup input terminal 1a. When there is active input, the system LSI device 1 executes the license information output program 2a to ascertain the identity of the object code and license information, and writes the verification result to the license register 14.

The waveform output circuit 18 issues an output to the license information output terminal 1b using the predetermined several types of regular waveforms, according to the contents of the license register 14. As a result, the synchronization signal is not always needed, unlike the first embodiment.

FIG. 8A and FIG. 8B show examples of output waveforms produced by the waveform output circuit 18 of the second embodiment. FIG. 8A shows an example where four types of regular waveforms are set in the waveform output circuit 18.

FIG. 8A(a) shows the output state when verification processing of the object code and license information of the application program 2 is not being performed, i.e., when the license information output program 2a is not been executed. In this case, because there is no output to the license information output terminal 1b, the logical value is “L”. In FIG. 8A and FIG. 8B, this state is referred to as “normal state.”

FIG. 8A(b) shows the output state when both object code and license information are coincident. In this case, the output waveform has a regular waveform with duty 50%.

FIG. 8A(c) shows the output state when the object code is not coincident, but the license information is coincident. The output waveform has a regular waveform with duty exceeding 50%.

FIG. 8A(d) shows the output state when the object code is coincident, but the license information is not coincident. The output waveform has a regular waveform with duty less than 50%.

FIG. 8A(e) shows the output state when the object code is not coincident, and the license information is not coincident. The output waveform has a regular waveform which overall has a duty of 50%, but this duty varies locally.

As described and illustrated, the waveform output circuit 18 generates different waveforms according to the results of verification of the object code and license information. The output waveform can be observed by for example connecting a synchroscope to the license information output terminal 1b, so that license information related to the software can be easily obtained. A detailed analysis can be performed by another method, such as for example that of the first embodiment.

FIG. 8B shows an example where four types of predetermined regular sounds are allocated by the waveform output circuit 18 according to the contents of the license register 14.

The four types of regular waveforms (sounds) in this embodiment are a plurality of sounds combined for output. This is similar to sound modulated by a modem device. For example, a sound modulated by a high frequency might be heard as a high-pitched sound, and a sound modulated by a low frequency would be heard as a low-pitched sound.

FIG. 8B(a) shows the output waveform in the normal state. This state is similar to that described in FIG. 8A(a).

FIG. 8B(b) shows the output state when both the object code and the license information are coincident. This output waveform represents a regular repeating sound with duty of 50%.

FIG. 8B(c) shows the output state when the object code is not coincident but the license information is coincident. The output waveform in this case generates a regular repeating sound with duty exceeding 50%.

FIG. 8B(d) shows the output state when the object code is coincident but the license information is not coincident. The output waveform generates a regular repeating sound with duty below 50%.

FIG. 8B(e) shows the output state when the object code is not coincident, and the license information is not coincident. The output waveform generates a regular repeating sound with overall duty of 50%, but such that the duty varies locally.

Thus, the waveform output circuit 18 issues waveforms at different audible frequencies according to the results of verification of the object code and license information. Accordingly, by connecting, for example, a speaker to the license information output terminal 1b via a capacitor, license information relating to the software can be easily heard and distinguished. A detailed analysis can be performed by another method, such as for example that of the first embodiment.

Thus in this embodiment, several preset regular waveforms can be generated by the waveform output circuit 18 according to the object code and license information of the application program 2, so that this output waveform can be used to easily identify license information relating to the software.

### Third Embodiment

Next, a third embodiment of the present invention is described with reference to FIG. 9 through FIG. 11. The third embodiment deals with a system LSI device mounted in a mobile communication terminal (for example, a PHS terminal, portable telephone, or similar). In this embodiment, license information for software embedded in the system LSI device is incorporated into a communication information sequence of the mobile communication terminal, and transmitted to an external communication device. Thus, the license information can be displayed on a monitor connected to the external communication device. Similar symbols are used to designate similar elements in the first, second and third embodiments.

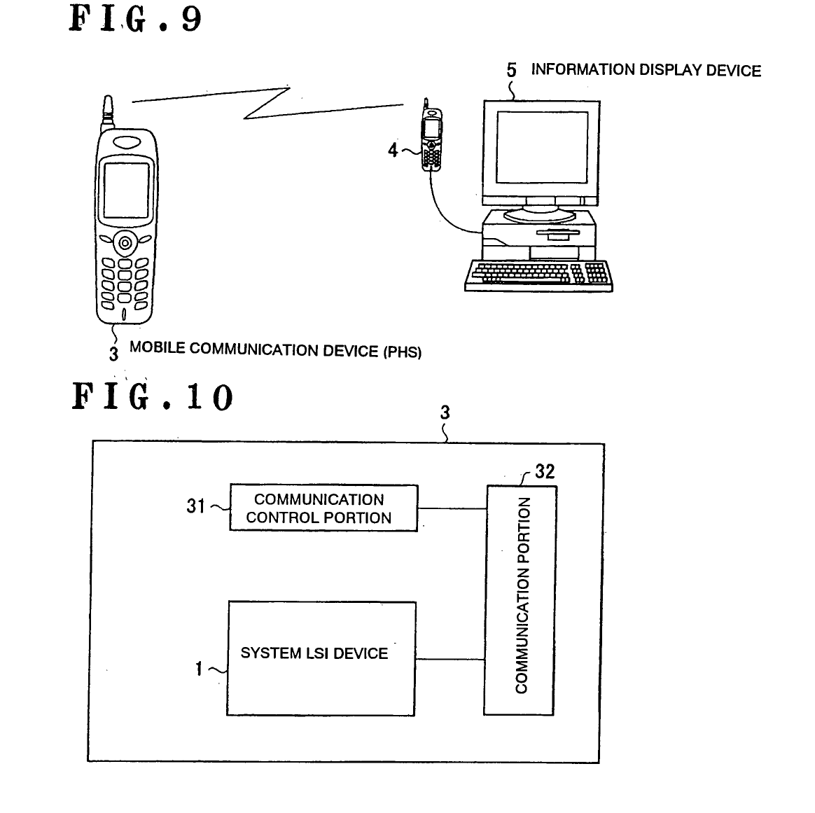

Referring to FIG. 9, a mobile communication device 3 to be verified has the system LSI device 1 (FIG. 10) in which is embedded the software for verification. There is a verifying mobile communication device 4 at a remote place. The verifying mobile communication device 4 is connectable to an information display device (monitor) 5.

In the following, the mobile communication devices 3 and 4 are PHS terminals. The mobile communication devices 3 and 4 are capable of mobile communication via a PHS base station and mobile communication network, not shown.

The system LSI device 1 mounted in the mobile communication device 3 can be either of the system LSI devices described in the first and second embodiments.

FIG. 10 is a block diagram of the mobile communication device 3. It should be noted that only major parts of the mobile communication device 3 are shown in FIG. 10. The mobile communication device 3 includes a system LSI device 1, communication control portion 31, and communication portion 32.

The communication control portion 31 controls PHS communication. The communication portion 32, under control of the communication control portion 31, receives verification results (object code and license information verification results) from the system LSI device 1, incorporates the verification results in a message to be used in a communication sequence, and transmits the message, containing the verification results, to the remote PHS 4.

When power is turned on, the mobile communication device 3 establishes communication with the PHS base station. The verification results are inserted into a message used in a communication sequence for communication to the PHS base station from the mobile communication device 3.

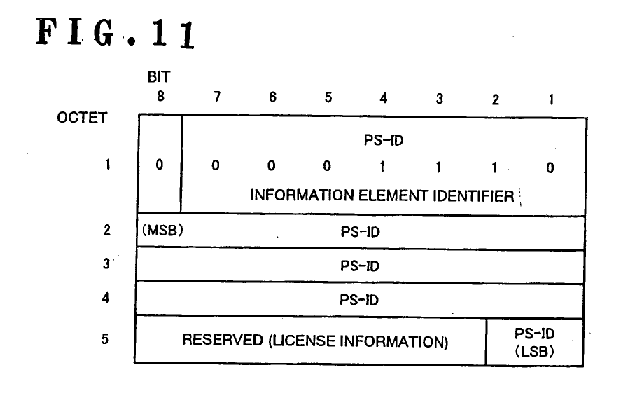

FIG. 11 shows a method of coding a PS-ID (PS identifier) contained in a PS-ID message or similar, among the messages used in PHS wireless management (RT: Radio Frequency Transmission Management).

According to standards for second-generation cordless telephones (ARIB Standard RCR STD-28 V3.3), the upper four bits of the fifth octet of the PS-ID are a reserved area, and normally nothing is written in the reserved area.

In this embodiment, the license information is incorporated into this reserved area. Even if the reserved area is four bits, the mobile communication device 3 is able to transmit information indicating whether the software concerned is licensed by the company O, information indicating whether there is coincidence of the object code, or information indicating whether there is coincidence of license information and similar.

This incorporation of verification results is performed by the MAC layer protocol software in concert with the license information output program 2a. Thus, the remote mobile communication device 4 receives the PS-ID containing the verification results, and can use the information display device 5 to display the verification results.

It should be noted that through combination with the reserved areas of other information element identifiers, the mobile communication device 3 can transmit more detailed license information to the remote mobile communication device 4. In this case, in addition to or instead of the verification results, the mobile communication device 3 may transmit the software license information itself to the remote mobile communication device 4.

The mobile communication device 4 is capable of wireless communication with the mobile communication device 3, and receives information transmitted by the mobile communication device 3 and provides the received information to the information display device 5. In this embodiment, the mobile communication device 4 is assumed to be a PHS terminal; but any suitable receiver may be employed as the mobile communication device 4 as long as it can communicate with the mobile communication device 3.

The information display device 5 displays the information supplied from the mobile communication device 4. The information display device 5 is, for example, a CRT, LCD or electroluminescence monitor.

Thus, in this embodiment, a mobile communication device carrying a system LSI device can incorporate software license information into the communication information sequence and transmit the communication information sequence to an external communication device, so that software license information can be ascertained via a monitor.

Further, in this embodiment, when there are no extra system LSI device terminals or in other cases, license information can be transmitted without using hardware resources. Also, in this embodiment, once a monitor system or similar is established, software license information can be easily displayed on a monitor. This is particularly convenient to developers and providers handling large quantities of embedded software.

### Other Embodiments

1) In the first through third embodiments, the license information or similar for software embedded in for example a portable telephone is ascertained; but the present invention can be applied not only to embedded software, but to software in general.

2) In the first embodiment, after ascertaining the identity of license information, object code identity is ascertained; but this need not be the order of verification, and license information identity may be ascertained after ascertaining the identity of the object code.

3) The present invention is not limited to the hardware configuration of the system LSI device shown in FIG. 3 and FIG. 7 or to the communication system configuration shown in FIG. 9. The present invention can be applied to a wide range of systems and devices.

Practically, this invention can be advantageously utilized in direct management in sales of embedded software licenses, and in particular can be advantageously utilized for identification of the software installed in individual products. Conventional software management has often relied upon indications on the exterior of the CD-ROM or other storage media. However, in this invention, individual software items can be easily identified even after installation, so that this invention is a new technology, applicable to all externally sold software products, insofar as incorporeal software can be managed as an incorporeal entity.

This application is based on a Japanese Patent Application No. 2004-206219 filed on Jul. 13, 2004 in Japan and the entire disclosure thereof is incorporated herein by reference.

What is claimed is:

1. A license information ascertainment device, which ascertains whether software to be executed conforms to a license contract, comprising:
a verification circuit for determining coincidence with verification information included in said software to verify legitimacy of execution of said software; and,
an output circuit for providing rights ownership information and/or license information for said software based on a verification result provided by the verification circuit.

2. The license information ascertainment device according to claim 1 further comprising a storage unit for storing the verification result by said verification circuit, and wherein the output circuit reads, when a read signal is input, said verification result from said storage unit, so as to provide said rights ownership information and/or license information for said software based on the verification result.

3. The license information ascertainment device according to claim 1, wherein said software includes rights ownership information for exclusive rights and license information.

4. The license information ascertainment device according to claim 1, wherein said verification circuit has an object code ascertainment portion which ascertains coincidence of all of or a portion of the object code of said software.

5. The license information ascertainment device according to claim 1, wherein said verification circuit has a license information ascertainment portion which ascertains coincidence of all of rights ownership information and license information for said software.

6. The license information ascertainment device according to claim 4, wherein said verification information is a code error detection bit table, and the code error detection bit table is a table of a plurality of code error detection bits allocated to each of a prescribed number of bits of the object code of said software, and
wherein said object code ascertainment portion ascertains coincidence of the object code of said software by comparing said code error detection bit table with said code error detection bits.

7. The license information ascertainment device according to claim 5, wherein a table of predetermined unidirectional function values is taken to be said verification information, and said license information ascertainment portion performs calculations for rights ownership information and license information using a predetermined unidirectional function, compares a calculation result with said table of unidirectional function values, and ascertains coincidence of rights ownership information and license information for said software.

8. The license information ascertainment device according to claim 2, wherein said output circuit generates a predetermined regular waveform according to a content stored in said storage unit.

9. The license information ascertainment device according to claim 8, wherein the waveform generated by said output circuit is a waveform modulated by a predetermined audible frequency according to the stored content of said storage unit.

10. The license information ascertainment device according to claim 2, wherein said output circuit has a communication control portion which performs communication control according to a prescribed communication scheme, and the communication control portion inserts the rights ownership information and license information for said software into communication information based on the prescribed communication scheme, and transmits the resulting communication information to an external device.

11. A license information ascertainment method for ascertaining whether software to be executed conforms to a license contract, comprising:
determining coincidence with verification information included in said software to verify legitimacy of execution of said software, thereby providing a verification result; and,
generating rights ownership information and/or license information for said software based on the verification result.

12. The license information ascertainment method according to claim 11 further comprising storing said verification result before said verification result is utilized to generate the rights ownership information and/or license information for said software, and wherein when a read signal is input, the verification result is read to generate the rights ownership information and/or license information for said software.

13. The license information ascertainment method according to claim 12, wherein a verification circuit is employed to determine said coincidence with verification information included in said software to verify the legitimacy of execution of said software, a storage unit is employed to store said verification result, and an output circuit is employed to read said verification result from said storage unit, and generate said rights ownership information and/or license information for said software based on said verification result.

14. The license information ascertainment method according to claim 11, wherein said software includes rights ownership information for exclusive rights and license information.

15. The license information ascertainment method according to claim 11, wherein said determining coincidence with verification information includes ascertaining coincidence of all of or a portion of the object code of said software.

16. The license information ascertainment method according to claim 11, wherein said determining coincidence with verification information includes ascertaining coincidence of all of rights ownership information and license information for said software.

17. A computer program product for ascertaining whether software to be executed conforms to a license contract, the computer program product comprising instructions operable to cause a computer to:
determine coincidence with verification information included in said software to verify legitimacy of execution of said software, thereby providing a verification result; and,
provide rights ownership information and/or license information for said software based on the verification result.

18. The computer program product according to claim 17, further comprising instructions to cause said computer to:
store the verification result; and
read, when a read signal is input, said verification result, and provide said rights ownership information and/or license information for said software.

19. The computer program product according to claim 17, wherein said instructions to cause the computer to determine coincidence with verification information includes sub-instructions to cause the computer to ascertain coincidence of all of or a portion of the object code of said software.

20. The computer program product according to claim 17, wherein said instructions to cause the computer to determine coincidence with verification information includes sub-instructions to ascertain coincidence of all of rights ownership information and license information for said software.
